(19) United States
(12) Patent Application Publication
(10) Pub. No.: US 2021/0141851 A1
(43) Pub. Date: May 13, 2021

(54) Deep Linking System and Method for Wrapped Links

(71) Applicant: See A Star LLC, Wayzata, MN (US)

(72) Inventor: Kenneth F. Krutsch, Minnetonka, MN (US)

(73) Assignee: See A Star LLC, Wayzata, MN (US)

(21) Appl. No.: 17/097,779

(22) Filed: Nov. 13, 2020

Related U.S. Application Data
(60) Provisional application No. 62/934,575, filed on Nov. 13, 2019.

(51) Int. Cl. G06F 16/955; G06F 16/957; G06Q 50/00

(52) U.S. Cl. CPC G06F 16/9566; G06Q 50/01; G06F 16/9574

(57) ABSTRACT

A system and method are presented for deep linking within a social media message. This is accomplished by allowing a link in the message to be wrapped by a social media server. The wrapped link is then opened in a browser embedded in a social media app, resulting in the display of a web page in the embedded browser that requests a user email address. When this email address is provided back to a server, an email message to that address is sent. The email address can directly include the deep link. When this deep link is opened in an email app, this link can directly perform a deep link into a second app since the user is now outside the embedded browser of the social media app. Alternatively, a web page accessed from the email message opens in a non-embedded browser, which then presents the deep link.

### CROSS-REFERENCE TO RELATED CASES

The present application claims the benefit of U.S. provisional patent application 62/934,575, filed on Nov. 13, 2019, which is hereby incorporated by reference in its entirety. The present application is also related to U.S. Ser. No. 16/862,339, filed on Apr. 29, 2020; U.S. Ser. No. 16/862,357, filed on Apr. 29, 2020; and U.S. Ser. No. 16/862,372, filed on Apr. 29, 2020 and issued as U.S. Pat. No. 10,819,758 on Oct. 27, 2020. These related applications are also incorporated herein by reference in their entireties.

### FIELD OF THE INVENTION

The present application is directed to the automatic launching of apps in a mobile computing environment using wrapped deep links.

### BRIEF DESCRIPTION OF THE DRAWINGS

FIG. 1 is a schematic diagram of a prior art system in which wrapped deep links are prevented from opening in an app.

FIG. 2 is a schematic diagram of a system that allows the automatic launching of apps in a mobile environment with wrapped deep links.

FIG. 3 is a schematic diagram of an embedded browser in a social media app showing a web page.

FIG. 4 is a schematic diagram of the embedded browser of FIG. 3 showing a differently configured web page.

FIG. 5 is a schematic drawing of a user interface showing an email notification presented on top of the web page of FIG. 3.

FIG. 6 is a schematic diagram of an email app operating on the mobile environment showing an email message.

FIG. 7 is a schematic diagram of an email app operating on the mobile environment showing an alternate email message.

FIG. 8 is a schematic diagram of a non-embedded browser showing a verification web page.

FIG. 9 is a flow chart showing a method for allowing the automatic launching of apps in a mobile environment with wrapped deep links.

FIG. 10 is a flow chart showing an alternate method for allowing the automatic launching of apps in a mobile environment with wrapped deep links.

### DETAILED DESCRIPTION

### Prior Art System 10

Mobile device operating systems, such as iOS from Apple, Inc. (Cupertino, Calif.) or the Android operating system from Google, Inc. (Mountain View, Calif.), allow individuals to follow URL links to open particular applications (apps) operating on the mobile device. In iOS, these links to applications are known as “universal links.” In Android, these links are called App Links. Such links are also referred to as deep links, as it is possible to link to particular content or features in an app by specifying this destination within the URL of the deep link. The links generally take the form of https formatted links. These links are allowed to open within an app only if data authorizing the link is found in app data stored on the mobile device and also found on the web server identified by that link. The data on the app identifies the web server's domain name, while the web server for that identified domain provides the identifier for the app running on the mobile device. If there is a match between this data, then the operating system will trust that the app can receive certain URLs that would otherwise be directed to the domain's web server. The data stored on the web server can specify paths and files that are available for handling at the app, thereby allowing some URLs at the domain to be processed by the app and other URLs to be handled by the web server through a browser operating on the user's mobile device.

If the user does not have the app downloaded on their mobile device, the URL will be handled by a browser on the mobile device in communication with the domain's web server. The web server may, however, link the user to the application store operating on the user's mobile device in order to download the app. Some third party service providers, such as Branch Metrics, Inc. (Redwood City, Calif.), provide services to allow the content specified by the deep link (the exact location within the app that is desired) to be maintained during the app download process, so that when the user has downloaded and installed the app, the correct content will be displayed by the newly downloaded app.

If a user selects a deep link, the operating system will normally determine how to handle this selection. If the operating system can identify an associated and verified app from the link, the operating system will pass the link to that app for it to handle. If the operating system cannot identify an app, the link will be passed to the browser for handling by the web server identified in the URL.

Some social media services interfere with the ability to perform this type of deep linking. Twitter (provided by Twitter, Inc. of San Francisco, Calif.), for instance, is a microblogging social networking site that will automatically wrap any links found in messages into a Twitter URL wrapper, which frequently has the following format: t.co/12345ABC. These wrapped links are frequently shorter than the original link, and therefore serve to reduce the character count of any links in the social media message. Twitter also implements a malware screening process, making these reformatted links arguably safer than the original links entered into the messages on the social media platform.

However, this automatic wrapping of links disrupts the functioning of deep links. FIG. 1 shows a prior art system 10 in which a message sender device 110 is sending a social media message 120 over a network 150 to a user device 100. Both the user device 100 and the message sender device 110 are computing devices. As such, both devices 100, 110 have a processor 102, 112, respectively, and memory 104, 114. The processors 102, 112 may be mobile devices processors, such as the processors created using the designs of Arm Ltd. (Cambridge, England). The memory 104, 114 can include long term storage to hold data and hold programming for the operating systems 106, 116 and for apps (such as apps 118, 160, 170, 180) running on the processors 102, 112.

This message 120 sent by the sender device 110 includes a deep link 122 to a particular app operating on the user computing device 100, namely second app 180. The message 120 may have been sent through a separate instance of the second app 118 operating on the sender device 110. The message 120 and its deep link 122 are received and processed by a social media server 140. This server 140 then makes the message 120 available to other social media users, including the user that is operating device 100. When the user receives the message 120, it is received and displayed inside a social networking app 160 operating on the device 100. Furthermore, when the user receives the message 120, the original deep link 122 has been replaced with a wrapped link 124 created by the social media server 140. When a user within the social networking app 160 selects this wrapped link 124, it points to URL shortener web domain used by the server 140 to wrap the link. If the social media server 140 operates the Twitter service, the URL shortener web domain will be t.co.

The social networking app 160 uses an embedded browser 162 that forms part of the app 160 to open the wrapped link 124. This embedded browser 162 is separate from an independent browser app 170 operating on the user device 100. The independent browser 170 might be Chrome (by Google) or Safari (by Apple). If the original deep link 122 were sent to the independent browser 170, the operating system 106 could identify this as a deep link, ensure that the second app 180 is available and authorized to handle this link, and then send the deep link 122 directly to the second app 180. Instead, when link 124 is opened from within the social networking app 160, the embedded browser 162 receives the wrapped and shortened link 124. The browser 162 contacts the URL shortener web domain to obtain the original link. Once the original link is obtained, the browser 162 will directly access the website server for the expanded URL without ever processing the link 124 as a potential deep link.

As a result, a deep link 122 to a second app 180 that is sent within this type of social media message 120 will never open the second app 180. Rather, the social networking server 140 and app 160 work together to frustrate these deep linking attempts. In this way, the social networking app 160 is able to keep the user within the embedded browser 162, which can be customized to help ensure that users will stay within the social networking app 160 as long as possible.

### System 20

FIG. 2 shows system 20 that allows deep linking in the context of a social network message 220. In this system, the message sender 110 is again attempting to send a message 220 to the user computing device 100 through the social media service provided by server 140. Once again, the message contains a URL link 222, and this link will be converted to a wrapped link 224. Thus, when the social networking app 160 displays message 220, the link 224 will be the shortened or wrapped link rather than a deep link to the second app 180.

In this case, however, the original link 222 included in the message 220 links to a web page 230 provided by a server 240. This server 240 is operated for the purpose of aiding in the creation of a deep link to the second app 180. In furtherance of this purpose, this web page 230 is specifically designed to obtain the email address for the user of device 100. FIG. 3 shows an example of web page 230 being presented in the embedded browser 162. This browser 162, although it is embedded into and controlled by the rest of the social networking app 160, generally is a tool provided by the operating system 106 running on the user computing device 100. On Apple's iOS operating system 106, the embedded browser will usually be an instance of a WebView powered by Webkit (by Apple), while on Android the WebView is typically powered by Blink (by the Chromium Project from Google). In some contexts, the embedded browser 162 will maintain data for the user, such as cookie 300 which stores a user's email address.

The web page 230 provided by the second app server 240 searches for the existence of this cookie 300. If found, the web page 230 will provide the email address 232 provided by this cookie 300 back to the second app server 240 (as shown in FIG. 2). Once the second app server 240 has the email address for the user of device 100, the server 240 will construct an email message 250 to the user that contains the deep link 252 to the second app 180.

In the preferred embodiment, the server 240 is able to maintain data that is associated with one another. In FIG. 2, the web link 222 is stored in association with the email address 232 for the user, which in turn is associated with the deep link location 252. Finally, the content 272 actually desired at location 252 is also stored.

If the embedded browser 162 cannot provide the email address 232 by finding a valid cookie 300 containing this information, the web page 400 shown in FIG. 4 can be presented on the embedded browser. This web page 400 simply requests the user to enter their email address at field 410 and then express a willingness to share their address to complete the deep link. In FIG. 4, this willingness is indicated by selecting the “join the fun” button 420. When this button is selected, the web page 400 will send the email address 232 input at location 410 to the server 240. While web page 230 and web page 400 are shown in FIGS. 3 and 4 as separate web “pages,” they are preferably different user interfaces provided by the same web page (found at a single URL), with the different interfaces being provided by programming embedded within the web page 230, 400.

After the email 250 is sent over the network 150, it is received by an email app 260 operating on the computing device 100. In most mobile device operating systems 106, the receipt of email 250 will trigger a notification to the user (although this behavior can be modified through settings set by the user). FIG. 5 shows an interface 500 where a notification 510 has “dropped-down” over the web page 230. This drop-down-down effect is not a requirement of the present invention, but it is helpful if the notification 510 is presented so that it is layered above (on top of) the user interface provided by the social networking app 160 as is shown in FIG. 5. In most cases, the user need only select this notification to open the email 250. In other words, the receipt of the email 250, the notification 510, and the selection of the notification 510 will cause the user to exit the social networking app 160 and enter the email app 260. The email app 260 will then display the message 250, as is shown in FIG. 6. The message 250 will have a message encouraging the user to select a user interface element, in this case button 600, in order to execute/open the deep link 252.

At this point, activation of the deep link 252 can be handled by the operating system 106 of the user computing device 100 as normal. If the second app 180 is found on the device, the operating system 106 will submit this link to the second app 180, and the second app 180 will open directly to the deep link location 270 identified by link 252.

In one embodiment, the deep link 252 is the same as the link 222 for the web page 230. As explained above, a deep link 252 is generally an https URL link. Although the embedded browser 162 that receives the web page link 222 (deep link 252 in this embodiment) will not pass along the link to the second app 180, it will attempt to open the link and present any web page found at that web location. In system 20, web page 230 provided by server 240 can be found on network 150 at the deep link location 252. This web page 230 will then provide email address 232 back to the server 240. Once the server 240 receives the email address, it already knows the deep link 252 because it served the web page 230 based on that link 252. Thus, it is a simple matter for the second app server 240 to generate the email 250 containing the deep link 252.

In other embodiments, the link 222 for the web page 230 is different than the deep link 252. The version of the second app 118 operating on the message sender device 110 knows that the link 222 it includes will be wrapped by the social media server 140. As a result, there is no need to format this web page link 222 as the actual deep link 252. Rather, the provided link 222 simply identifies the web address for web page 230. This link 222 can, however, include enough detail so that the second app server 240 can generate the actual deep link 252 based on the request for web page 230.

One benefit for maintaining a distinction between web page link 222 and the actual deep link 250 becomes apparent if the second app 180 is not currently found on the user computing device 100. In this case, the deep link 252 to the second app 180 will be analyzed by operating system 106 and, in the absence of app 180, the link will be provided to the general browser 170. This is shown by the dashed-line arrows on FIG. 2. The browser will then contact the web server at this URL. If this deep link URL 252 were the same as the web page URL 222, the web server 240 would simply return web page 230 to the browser 170. If the deep link URL 252 is allowed to differ from the web page URL 222, a different result can occur. Using known third-party services, such as the Branch service provide by Branch Metrics, Inc., the browser 170 that accesses deep link URL 252 can be directed to open a link to an app store 280 for the operating system 106. This can itself be a deep link to the download location for the second app 180. The user can then download the second app 180. When the user opens the second app 180, the Branch service will ensure that the app 180 will open at the deep link location 270.

In yet another embodiment, the email message 250 received by the user takes the form of email message 700 as shown in FIG. 7. In this embodiment, the email message 700 presents a code 710 to the user (such as a six digit numeric code). Along with this code 710 is a link 720 to open a web page on the standard browser 170 operating on user device 100. If the user follows this link 720, web page 800 (as shown in FIG. 8) is opened in browser 170 outside of the social networking app 160. This web page 800 includes input 810 and a button/link 820. When the user enters the code 710 into input 810 and clicks link 820, the server 240 can verify the code and, consequently, verify that the email address 232 it received is accurate. Alternatively, instead of having the user manually enter code 710, the link 720 can both open the web page 800 and insert the code 710 into the input area 810. The user would still then select button 820. At this point, the server 240 will directly return the deep link 252 to the browser 170. The operating system 106 will identify this link 252 as a deep link, and then open the link at the deep link location 270 in the second app 180.

One benefit of verifying the email address in this manner is that the second app server 240 will have more confidence that the email address 232 that is stored at the server 240 is the true email for the user. The email 232 is stored in association with the deep link 252 and its associated content 272. As a result, it is possible for a user to newly install the app 180 from the app store 280 and still make it to deep link location 270 even in the absence of the Branch service or other similar services. In this case, the user would download the app 180 and then log into the app using their email address. When they have logged into their existing account or created a new account based on this email address, the second app 180 will communicate with the second app server 240 to determine whether any deep link locations have been stored for this email address 232. If so, the second app 180 will receive this location from server 240 and then automatically open that deep link location 270 once the log in process is completed.

### Methods

A method 900 for implementing the present invention is shown in FIG. 9. This method 900 begins at step 905, in which a web link 222 is created by the sender device 110. As explained above, this web link 222 may take the form of a deep link 252 to the second app 180, or to a link to an associated web page provided by the second app server 240.

The web link 222 is preferably generated by an instance of the second app 118 running on the message sender device 110 in conjunction with the second app server 240. The second app server 240 must be able to generate the web page 230 at the location of the web link 222. Furthermore, the second app server 240 will associate any content 272 found at the deep link location 270 and the deep link 252 itself with this particular web link location 222. Thus, in one embodiment, the second app 118 creates some content or schedules some performance or event that is made available through the second app server 240. In particular, this content or schedule is made available to others at a deep link location 270 in the second app 180. The connection between the web link 222 and the deep link location 270 is then established by either the second app 118 or the second app server 240 and is stored at the server 240. After this connection is established, the web link 222 is made available to the instance of the second app 118 at the sender device 110.

Next, this web link 222 is embedded in a social media message 220 at step 910. This message 220 will then be received by the social media server 150, the link will be wrapped according to the requirements of the social media server 150, and the original message 220 with the now wrapped web link 224 will then be received at a customer device at step 915.

At step 920, the user that is operating device 100 examines the message 220 in their social networking app 160 and then selects the wrapped web link 224. This link is then opened as a web page 230 in the embedded browser 162 at step 920. This web page 230 is served by second app server 240. If the web page 230 has access to the email address 232 of the user (as determined by step 925), the web page 230 will return that address 232 to the server 240 at step 935. The web page 230 may have access to the email address 232 through stored data accessible by the embedded browser 162, such as through cookie 300. If step 925 determines that the web page 230 does not have immediate access to the email address 232, the page 230 will request that this address 232 be input by the user (step 930). The address 232 can then be stored in cookie 300 in case it is needed later, and also returned to the server 240 at step 935.

At step 940, an email message 250 is created at the server 240 that contains a deep link 252 to the second app 180. This email message 250 is then sent to the user computing device 100 at step 945, and then opened by the user within their email app 260 at step 950. At step 955, the user activates (selects) the deep link 252 within their email app 260. This will cause the operating system 106 of the user device 100 to examine this deep link 252 to identify a selected and authorized application (second app 180) that is able to handle this deep link 252 (step 960). If this identified app 180 is found on the device 100 (as determined by step 965), then the second app 180 will be opened at the appropriate deep link location 270 specified by this link 252 at step 975, and the method 900 will end at step 980.

If the operating system 106 does not identify second app 180 as being able to handle this deep link 252 at step 960, this is likely because the second app 180 has yet to be installed onto the user computing device 100. As a result, step 965 will indicate that the app 180 is not available. In this case, the deep link 252 will be treated like a normal web link. The non-embedded browser 170 will attempt to open the link 252, and the second app server 240 (or a third party server such as one operated under the Branch service) will respond with a link causing the user device to open the app store 280 at the appropriate location for downloading the second app 180. The user can then download the second app 180 (step 970) and proceed to identify themselves to the app 180 (such as by logging into the app 180 or by establishing a new account on the app 180). Once completed, the service provided by Branch can ensure that the second app 180 will open at deep link location 270 at step 975, and the method 900 will end at 980.

An alternative method 1000 is presented through the flow chart shown on FIG. 10. This method 1000 is similar to method 900, and identical steps in method 1000 utilize the same figure numbers as shown in FIG. 9 for method 900. Different steps utilize new figure numbers and are further distinguished in FIG. 10 through the use of a thicker border around those steps.

Consequently, it is seen that method 1000 is the same as method 900 up until the email address 232 is returned to the second app server 240 at step 935. At this point, step 1040 will create an email message 700 that includes a verification code 710, such as that shown in FIG. 7. This message is then sent to the user (step 945) and opened on the email app 260 on the user device 100 (step 950).

The user then activates the verification link 720 (step 1052). This causes a request to be sent to the second app server 240, which responds with a verification web page 800 that will open in the non-embedded web browser 170 (step 1054). As shown in FIG. 8, this page 800 can allow the user to enter a verification code 710 into an input 810 on the page 800. Alternatively, the verification link 720 can include the verification code 710 in its request to the second app server 240, as was explained above. When the user indicates that they are ready to progress (such as by clicking the next button 820), the server 240 will receive this verification of the email address 232. This will cause the server 240 to store this verified email address 232 in association with information that identifies the deep link location 270 in the second app 180. The deep link location 270 will have been received by the second app server 240 in the initial request for web page 230 and will have been associated with the email 250 sent in step 945.

The deep link URL 252 will then be presented to the non-embedded browser 170 at step 1058. This will cause the operating system 106 to examine this link 252 at step 960 and determine whether app 180 is available to handle this link 252. If not, the second app 180 is downloaded from the app store 280 at step 970. Once the user has logged into this app 180, they will identify their email address 232 at step 1072. The second app 180 will then communicate with the second app server 240 and determine whether this email address 232 has been saved in association with a deep link location 270. The server 240 will examine its saved data, and then identify and return the deep link location 270. This occurs at step 1074. At this point, the newly installed copy of the second app 180 will open at deep link location 270, and the method 1000 will end at step 1080.

### Context

The related applications describe a system and method utilizing an app to facilitate multiple party communications over an app operating on a mobile device. In one embodiment, the second app 180 described herein comprises the multi-party communications app described in these related applications. For example, U.S. Pat. No. 10,819,758 (the '758 patent) describes a meet now process. In FIG. 26 of the '758 patent, a social media message 2600 is shown that includes a link 2520 to start a “meet now stream” form of multi-party communications. This link may take the form of a deep link 252 to an application 180 for connecting to the meet now stream on a user device 100. The deep link 252 can link the user directly to the meet now interface of the app 180, including, for example, the payment interface 3100 shown on FIG. 31 of the '758 patent.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. On a user computing device running a social media app and a second app, a method for accomplishing deep linking to a deep link location in the second app comprising:
a) receiving at the social media app a social media message comprising a wrapped link to a web location on a second app server, the web location being associated with the deep link location on the second app server;
b) in response to a request to follow the wrapped link in the social media app, displaying in an embedded browser on the social media app a web page from the web location, wherein the embedded browser will not open deep links in any separate apps;
c) transmitting from the web page on the embedded browser to the second app server a user email address;
d) receiving from the second app server an email message addressed to the user email address containing a deep link to the deep link location in the second app;
e) opening the email message on an email app running on the user computing device;
f) in response to a request to follow the deep link, opening the second app at the deep link location.

2. The method of claim 1, wherein both the deep link and the web location in the wrapped link are both URL https links.

3. The method of claim 2, wherein the deep link and the web location in wrapped link are the same URL http link.

4. The method of claim 1, wherein an operating system on the user computing device evaluates the deep link and confirms that the second app is authorized to open the deep link.

5. The method of claim 1, wherein the web page requests input of the user email address when opened in the embedded browser.

6. The method of claim 1, wherein the web page reads the user email address from data accessible by the embedded browser.

7. The method of claim 6, wherein the data is stored in a web cookie.

8. The method of claim 1, wherein an operating system on the user computing device provides a notification of the receipt of the email message that is layered on top of a user interface provided by the social media app.

9. On a user computing device running a social media app and a second app, a method for accomplishing deep linking to a deep link location in the second app comprising:
a) receiving at the social media app a social media message comprising a wrapped link to a web location on a second app server, the web location being associated with the deep link location on the second app server;
b) in response to a request to follow the wrapped link in the social media app, displaying in an embedded browser on the social media app a web page from the web location, wherein the embedded browser will not open deep links in any separate apps;
c) transmitting from the web page on the embedded browser to the second app server a user email address;
d) storing at the second app server the user email address in association with the deep link location;
e) receiving from the second app server an email message addressed to the user email address containing a first deep link to the deep link location in the second app;
f) opening the email message on an email app running on the user computing device;
g) in response to a request to follow the first deep link, confirming that the second app is not installed on the user computing device;
h) after confirming that the second app is not installed on the user computing device, following the first deep link to a second web location;
i) receiving from the second web location a second deep link to an app store location for downloading the second app;
j) downloading the second app on the user computing device;
k) opening the second app on the user computing device and receiving input of the user email address through the second app;
l) at the second app, communicating the user email address to the second app server;
m) at the second app, receiving the deep link location from the second app server that is stored in associated with the user email address; and
n) at the second app, opening the deep link location.

10. The method of claim 9, wherein the web page requests input of the user email address when opened in the embedded browser.

11. The method of claim 9, wherein the web page reads the user email address from data accessible by the embedded browser.

12. The method of claim 11, wherein the data is stored in a web cookie.

13. On a user computing device running a social media app and a second app, a method for accomplishing deep linking to a deep link location in the second app comprising:
a) receiving at the social media app a social media message comprising a wrapped link to a web location on a second app server, the web location being associated with the deep link location on the second app server;
b) in response to a request to follow the wrapped link in the social media app, displaying in an embedded browser on the social media app a web page from the web location, wherein the embedded browser will not open deep links in any separate apps;
c) transmitting from the web page on the embedded browser to the second app server a user email address;
d) receiving from the second app server an email message addressed to the user email address containing a second link to a second web location;
e) opening the email message on an email app running on the user computing device;
f) in response to a request to follow the second link, opening on a non-embedded browser the second link to the second web location; and
g) receiving from the second web location a deep link to the deep link location in the second app; and
h) opening the second app at the deep link location.

14. The method of claim 13, wherein the web page requests input of the user email address when opened in the embedded browser.

15. The method of claim 13, wherein the web page reads the user email address from data accessible by the embedded browser.

16. The method of claim 15, wherein the data is stored in a web cookie.

17. On a user computing device running a social media app and a second app, a method for accomplishing deep linking to a deep link location in the second app comprising:
a) receiving at the social media app a social media message comprising a wrapped link to a web location on a second app server, the web location being associated with the deep link location on the second app server;
b) in response to a request to follow the wrapped link in the social media app, displaying in an embedded browser on the social media app a web page from the web location, wherein the embedded browser will not open deep links in any separate apps;
c) transmitting from the web page on the embedded browser to the second app server a user email address;
d) storing at the second app server the user email address in association with the deep link location;
e) receiving from the second app server an email message addressed to the user email address containing a second link to a second web location;
f) opening the email message on an email app running on the user computing device;
g) in response to a request to follow the second link, opening on a non-embedded browser the second link to the second web location; and
h) receiving from the second web location a first deep link to the deep link location in the second app; and
i) in response to receiving the first deep link, confirming that the second app is not installed on the user computing device;
j) after confirming that the second app is not installed on the user computing device, following the first deep link to a second web location;
k) receiving from the second web location a second deep link to an app store location for downloading the second app;
l) downloading the second app on the user computing device;
m) opening the second app on the user computing device and receiving input of the user email address through the second app;
n) at the second app, communicating the user email address to the second app server;
o) at the second app, receiving the deep link location from the second app server that is stored in associated with the user email address; and
p) opening the second app at the deep link location.

18. The method of claim 17, wherein the web page requests input of the user email address when opened in the embedded browser.

19. The method of claim 17, wherein the web page reads the user email address from data accessible by the embedded browser.

20. The method of claim 19, wherein the data is stored in a web cookie.
